(19) United States
(12) Patent Application Publication
(10) Pub. No.: US 2025/0084223 A1
(43) Pub. Date: Mar. 13, 2025

(54) MIXED POLYMER BODY PLATE AND MANUFACTURING METHOD THEREOF

(71) Applicant: HONG MAO ACCESSORIES CO., LTD., Kaohsiung City (TW)

(72) Inventor: CHING-TING YEH, Kaohsiung City (TW)

(21) Appl. No.: 18/432,075

(22) Filed: Feb. 5, 2024

(30) Foreign Application Priority Data
Sep. 11, 2023 (TW) 112134548

(51) Int. Cl. C08J 5/18; B32B 27/08; C08J 3/00

(52) U.S. Cl. CPC C08J 5/18; B32B 27/08; C08J 3/005; B32B 2272/00

(57) ABSTRACT

A manufacturing method for mixed polymer body plates includes: prefabricating at least one polymer material selected from a plastic material, a rubber material or combination thereof; prefabricating at least one solvent selected from a single solvent or a mixed solvent; at room temperature mixing and stirring the polymer material with the solvent to obtain a mixed polymer material which contains no cross linker, extrusion forming hardening the mixed polymer material to obtain a polymer colloidal plate.

### BACKGROUND OF THE INVENTION

### (a) Technical Field of the Invention

The present invention relates to a pulverization pot structure of a mixed polymer body plate and a manufacturing method thereof, and more particularly to a polymer body plate that is mixed at room temperature or normal temperature, and a manufacturing method thereof, and even more particularly to a polymer body plate in which recycled waste is optionally mixed, and a manufacturing method thereof.

### (b) Description of the Prior Art

With regard to plastic foams that are already known and the manufacturing methods thereof, such as: Taiwan Patent Publication No. TW-576782, issued to an invention for “a method for manufacturing plastic foam having open cells”, discloses a method for manufacturing a plastic foam having open cells. The method for manufacturing plastic foam having open cells includes: mixing an ethylene-vinyl acetate (EVA) plastic material or a polyethylene (PE) plastic material with a foaming agent, a crosslinking agent, and an additive at a predetermined ratio to form a primitive plastic material.

Continuing from the above, the abovementioned method for manufacturing plastic foam having open cells disclosed in Taiwan Patent Publication No. TW-576782 further includes: selecting a hollow ceramic ball or a hollow particulate sphere, wherein the hollow ceramic ball or the hollow particulate sphere is not bondable with or not reactive with the primitive plastic material, and subjecting the hollow ceramic ball or the hollow particulate sphere to blending so that the hollow ceramic ball or the hollow particulate sphere is uniformly distributed in the primitive plastic material to form a mixed material.

Continuing from the above, the abovementioned method for manufacturing plastic foam having open cells disclosed in Taiwan Patent Publication No. TW-576782 further includes: placing the mixed material in a primary mold for easy application of a predetermined temperature for pressurizing and heating, so that the foaming agent is decomposed to generate a gas for forming an already-one-round foaming body.

Continuing from the above, the abovementioned method for manufacturing plastic foam having open cells disclosed in Taiwan Patent Publication No. TW-576782 further includes: removing the already-one-round foaming body from the primary mold, such that, at the instant of opening of the mold, due to the release of pressure and instantaneous expansion of the gas contained in the mixed material, a gas chamber structure having multiple cells is generated, while due to the hollow ceramic ball or the hollow particulate sphere being not bondable with or not reactive with the primitive plastic material, a solid shell of a cell is caused to instantaneously expand to generate a cracked passageway to form an open foaming body.

However, the crosslinking agent is necessary for forming the plastic foam in the abovementioned method for manufacturing plastic foam having open cells disclosed in Taiwan Patent Publication No. TW-576782, and the manufacturing process requires implementation of a high-temperature mixing or blending operation. Thus, it does not suit the need for room-temperature or low-temperature operation techniques that have a low energy consumption, so that there is a potential need for further improvement with respect to the material and the process thereof.

Another known PE/PP crosslinked plastic material recycling and fabrication method thereof, such as: Taiwan Patent Publication No. TW-1278476 for “PE/PP crosslinked plastic material recycling fabrication method”, discloses a PE/PP crosslinked plastic material recycling fabrication method. The PE/PP crosslinked plastic material recycling fabrication method includes: operating a first pulverization machine to further mince shatters of foamed plastic wastes into tiny plastic chips so as to prevent the tiny plastic chips from flowing backwards in an extrusion machine, wherein the foamed plastic waste shatters have a degree of crosslinking, and the degree of crosslinking is between 40 and 60.

Continuing from the above, the abovementioned PE/PP crosslinked plastic material recycling fabrication method of Taiwan Patent Publication No. TW-1278476 further includes: melting down the tiny plastic chips into a semi-fluidic paste like plastic material and operating a first extrusion machine to extrude, with a high pressure, the semi-fluidic paste like plastic material into a strip like plastic material in order to remove air contained in the material and to break the crosslinking bonding pattern of molecules, the operation temperature being between 150° C. and 240° C., the operation pressure being between 250 and 650 psi.

Continuing from the above, the abovementioned PE/PP crosslinked plastic material recycling fabrication method of Taiwan Patent Publication No. TW-1278476 further includes: cutting the strip like plastic material into multiple flask like pellets and also subjecting the multiple flask like pellets to air cooling to form a solid particle like plastic material, of which the degree of crosslinking is between 15 and 20; allowing foaming agents and chemical additives contained in the material of the solid particle like plastic material to be released therefrom through releasing pressure and action of high temperature and high pressure; and subjecting the solid particle like plastic material to pulverization by means of a second pulverization machine in order to obtain a pulverized plastic material to prevent back flowing thereof in an extrusion machine.

Continuing from the above, the abovementioned PE/PP crosslinked plastic material recycling fabrication method of Taiwan Patent Publication No. TW-1278476 further includes: subjecting the pulverized plastic material to melting by means of a second extrusion machine to form a semi-fluidic paste like plastic material, wherein the operation temperature is between 125° C. and 240° C. and the operation pressure is between 500 psi and 2500 psi, to be extruded by the second extrusion machine into multiple strip like plastic materials in order to further remove voids contained in the material and to break the crosslinking bonding pattern of molecules for restoring back into a high-molecule plastic material that is close to an original base material.

Continuing from the above, the abovementioned PE/PP crosslinked plastic material recycling fabrication method of Taiwan Patent Publication No. TW-1278476 further includes: applying a hydraulic die screen and a pelletizing die to cut and break the multiple strip like plastic materials into multiple flask like pellets, of which the degree of crosslinking is reduced to between 6 and 10; subjecting the multiple flask like pellets to oscillating tank or air cooling to form multiple solid flask like plastic materials; and subjecting the multiple solid flask like plastic materials to recovery.

However, the abovementioned PE/PP crosslinked plastic material recycling fabrication method of Taiwan Patent Publication No. TW-1278476 necessarily involves crosslinking agents in order to make the crosslinked plastic material, and the fabrication process includes a high-temperature melting operation. Thus, it does not suit the need for room-temperature or low-temperature operation techniques that have a low energy consumption, so that there is a potential need for further improvement with respect to the material and the process thereof.

Another known method for manufacturing gas-permeable plastic foam, such as: Taiwan Patent Publication No. TW-1389790 for “a manufacturing method for gas-permeable plastic foam having function of electrical conduction”, discloses a manufacturing method for gas-permeable plastic foam having function of electrical conduction. The manufacturing method for gas-permeable plastic foam having function of electrical conduction includes: primary blending: uniformly blending and heating a carbon-contained material and a plastic material by means of extrusion equipment or stirring equipment in order to form a base material; and pelletizing: cutting the base material with pelletizing equipment to form multiple base pellets in the form of particles.

Continuing from the above, the abovementioned manufacturing method for gas-permeable plastic foam having function of electrical conduction disclosed in Taiwan Patent Publication No. TW-1389790 further includes: secondary blending: blending the base pellets with a plastic material and a foaming agent, a crosslinking agent, an additive, and multiple hollow particulate spheres to form a material, wherein the hollow particulate spheres are not bondable with and not reactive with the base pellets.

Continuing from the above, the abovementioned manufacturing method for gas-permeable plastic foam having function of electrical conduction disclosed in Taiwan Patent Publication No. TW-1389790 further includes: foaming: placing the material in a mold to carry out pressurizing and heating, so that the foaming agent contained in the material is heated and decomposed to generate a gas to thereby form a thermally decomposable gas.

Continuing from the above, the abovementioned manufacturing method for gas-permeable plastic foam having function of electrical conduction disclosed in Taiwan Patent Publication No. TW-1389790 further includes: shaping: making use of instantaneous pressure release at the time of opening the mold to allow gas contained in the material to instantaneously expand to generate multiple cells, while due to the hollow particulate spheres not causing bonding reaction with the carbon-contained material, a plastic shell of a cell is caused to instantaneously expand during the expansion course of the cell to form a cracked passageway so as to obtain a gas-permeable plastic foam having function of electrical conduction that includes an open cellular structure.

However, the abovementioned manufacturing method for gas-permeable plastic foam having function of electrical conduction disclosed in Taiwan Patent Publication No. TW-1389790 necessarily involves a cross-linking agent in order to make the gas-permeable plastic foam having function of electrical conduction, and the manufacturing process includes a high-temperature mixing or blending operation. Thus, it does not suit the need for room-temperature or low-temperature operation techniques that have a low energy consumption, so that there is a potential need for further improvement with respect to the material and the process thereof.

Another known plastic foaming pre-formed space forming method, such as: Taiwan Patent Publication No. TW-1592277 for “a plastic foaming pre-formed space forming method”, discloses a plastic foaming pre-formed space forming method. The plastic foaming pre-formed space forming method includes: plastic raw material: preparing a plastic raw material; chemical agent: preparing a chemical agent, the chemical agent including a foaming agent of around 3%, a crosslinking agent of around 1 to 2%, a processing aid agent, and a pigment; stirring with bending machine: placing the plastic raw material and the chemical agent in a blending machine for stirring at 35° C. to 45° C. to have them uniformly mixed to obtain a mixed material.

Continuing from the above, the abovementioned plastic foaming pre-formed space forming method of Taiwan Patent Publication No. TW-1592277 further includes: pelletizing with pelletizing machine: subjecting the mixed material to drawing and pelletizing with a pelletizing machine at 125° C. to 135° C. to obtain multiple plastic particles; embedding with primary shaping: having the multiple plastic particles foaming at a predetermined ratio in a first shaping mold, wherein the predetermined ratio is between 1.6 to 1.8 in order to reduce to form a first shaped piece, and embedding at least one space element in the first shaping mold, and injecting the multiple plastic particles into the first shaping mold at 135° C. to 145° C. by means of an injection machine so as to have the space element enclosed in the first shaped piece after cooling down.

Continuing from the above, the abovementioned plastic foaming pre-formed space forming method of Taiwan Patent Publication No. TW-1592277 further includes: heating and pressurizing for foaming forming: placing the first shaped piece in a foaming mold and carrying out heating and pressurizing for foaming forming at 185° C. to 195° C.; space element detaching and recovering: the space element being detaching from the first shaped piece due to material difference after the foaming forming so as to form a space; and foamed product: finally obtaining a plastic foamed product.

However, the abovementioned plastic foaming pre-formed space forming method of Taiwan Patent Publication No. TW-1592277 necessarily involves a cross-linking agent in order to make the mixed material and the multiple plastic particles, and the manufacturing process includes an energy-consuming heating and pelletizing operation. Thus, it does not suit the need for room-temperature or low-temperature operation techniques that have a low energy consumption, so that there is a potential need for further improvement with respect to the material and the process thereof.

Obviously, the abovementioned Taiwan Patent Publication Nos. TW-576782, TW-1278476, TW-1389790, and TW-1592277 are discussed as a reference for the background techniques of the present invention and for illustrating the state-of-art technical progress and are not intended to limit the scope of the present invention.

As known from the above patents, the known plastic material recycling techniques all need to add a crosslinking agent or use a material having a crosslinking function, and also requires high-temperature mixing or blending and thermally melting pelletizing operation. Thus, the known techniques apparently suffer the shortcoming of high energy consumption. Further, the known plastic material recycling techniques are only applicable to use of recyclable plastic materials of similar properties for reuse, and for certain special plastic (or rubber) materials, incineration and dumping are only applicable for disposition thereof, and it is not possible to apply the known techniques for recycling and reuse. Thus, there are still limitations for the known plastic material recycling techniques, and it is not possible to effectively utilize the plastic (rubber) wastes. This is shortcoming for not repeated use, and defects of ecological pollution and resources consumption may require further improvement.

In view of the above, to suit the above needs, the present invention provides a mixed polymer body plate and a manufacturing method thereof, in which at least one polymer material is prepared, wherein the polymer material is selected from a plastic material, a rubber material, or a combination thereof, and at least one solvent is prepared, wherein the solvent is selected from a single solvent or a mixed solvent, the polymer material and the solvent are mixed and stirred at room temperature to obtain a mixed polymer material, wherein the mixed polymer material is added with a various-material-mixed plastic waste material, and the polymer material does not use a crosslinking agent or a material having a crosslinking function, and the mixed polymer material is subjected to extrusion forming to obtain a shaped polymer colloidal plate, wherein no plastic pelletizing operation implemented in advance is required so that known mixed plastics and manufacturing methods thereof requiring use of crosslinking agents and technical issues of energy consumption for heat-supplying energy-consuming melting operations and plastic pelletizing operations can be changed.

### SUMMARY OF THE INVENTION

The primary objective of a preferred embodiment of the present invention is to provide a mixed polymer body plate and a manufacturing method thereof, in which at least one polymer material is prepared, wherein the polymer material is selected from a plastic material, a rubber material, or a combination thereof, and at least one solvent is prepared, wherein the solvent is selected from a single solvent or a mixed solvent according to raw material property and ratio of functionality, and the polymer material and the solvent are mixed and stirred at room temperature to obtain a mixed polymer material, wherein the polymer material does not use a crosslinking agent or a material having a crosslinking function, and the mixed polymer material is subjected to extrusion forming to obtain a shaped polymer colloidal plate, wherein purposes of efficacy that no energy consumption is required for a plastic pelletizing operation implemented in advance, that a fusion operation can be carried out at room temperature, and that plastic pelletizing operation can be avoided are achieved, and zero emission is realized for waste plastic (rubber) materials to have the product recyclable for persistent fabrication recycling and reuse through the entire life cycle.

To achieve the above purposes, a mixed polymer body plate according to a preferred embodiment of the present invention comprises:
at least one the polymer material, which is selected from a plastic material, a rubber material, or any combination thereof;
at least one solvent, which is selected from a single solvent or a mixed solvent;
a mixed polymer material, wherein the polymer material and the solvent are mixed and stirred at a normal temperature to obtain the mixed polymer material; and
a polymer body plate, wherein the mixed polymer material is subjected to extrusion forming to obtain a shaped polymer body plate;
wherein the mixed polymer material uses no crosslinking agent or a material having a crosslinking function, wherein the shaped polymer material body plate requires no plastic pelletizing operation before being shaped, and allows mixed wastes, which are currently not recyclable and can only be incinerated, to add therein as a raw material.

In a preferred embodiment of the present invention, the plastic material is selected from a plastic fragment material, a waste plastic fragment material, a plastic sheet material, a waste plastic sheet material, a plastic powder material, a waste plastic powder material, or any combination thereof, and the rubber material is selected from a rubber fragment material, a waste rubber fragment material, a rubber sheet material, a waste rubber sheet material, a rubber powder material, a waste rubber powder material, or any combination thereof.

In a preferred embodiment of the present invention, the plastic material or the rubber material is selected from a material that is soluble in the solvent, a material that is soluble in the organic solvent, a material that is insoluble in the solvent, a material that is insoluble in the organic solvent, or any combination thereof.

In a preferred embodiment of the present invention, the mixed polymer material is further added with at least one functional material.

In a preferred embodiment of the present invention, the functional material is selected from a foaming agent, a processing aid, a fire retardant, a pigment, or any combination thereof.

To achieve the above purposes, a manufacturing method for a mixed polymer body plate according to a preferred embodiment of the present invention comprises:
preparing at least one polymer material, wherein the polymer material is selected from a plastic material, a rubber material, or any combination thereof;
preparing at least one solvent, wherein the solvent is selected from a single solvent or a mixed solvent;
mixing and stirring the polymer material and the solvent at a normal temperature to obtain a mixed polymer material, wherein the mixed polymer material uses no crosslinking agent or a material having a crosslinking function; and
subjecting the mixed polymer material to extrusion forming to obtain a shaped polymer body plate, wherein the shaped polymer material body plate requires no plastic pelletizing operation before being shaped, and allows mixed wastes, which are currently not recyclable and can only be incinerated, to add therein as a raw material.

In a preferred embodiment of the present invention, the polymer material is selected from an insoluble plastic material, wherein the insoluble plastic material forms an aggregate.

In a preferred embodiment of the present invention, the solvent dissolves a portion of the plastic material or the rubber material to form at least one polymer material body.

In a preferred embodiment of the present invention, the polymer material body is fusing and attaching for grafting on the plastic material or the rubber material.

In a preferred embodiment of the present invention, the shaped polymer material body plate has an extrusion surface.

In a preferred embodiment of the present invention, the shaped polymer material body plate is processable to generate a processing waste, and the processing waste recyclable and reusable as a recycled waste polymer material.

### BRIEF DESCRIPTION OF THE DRAWINGS

FIG. 1 is a block diagram for a mixed polymer body plate according to a preferred embodiment of the present invention.

FIG. 2 is a schematic view showing a structure of a mixed polymer body plate according to a first preferred embodiment of the present invention.

FIG. 3 is a schematic view showing a structure of a mixed polymer body plate according to a second preferred embodiment of the present invention.

FIG. 4 is a flow chart showing a manufacturing method for a mixed polymer body plate according to a preferred embodiment of the present invention.

FIG. 5 is a top plan view showing a structure of a mixed polymer body plate according to a third preferred embodiment of the present invention.

### DETAILED DESCRIPTION OF THE PREFERRED EMBODIMENTS

The structure of a mixed polymer colloidal plate according the preferred embodiment of the present invention, the functionality thereof, the manufacturing method thereof, and the operation method thereof are applicable to all sorts of thermally insulating plate products, all sorts of sound-absorbing plate products, all sorts of fire-proof plate products, all sorts of floor tile plate products, all sorts of steel plate products, all sorts of antimildew plate products, or all sorts of other types of functional plate products, but this does not limit the scope of application of the present invention.

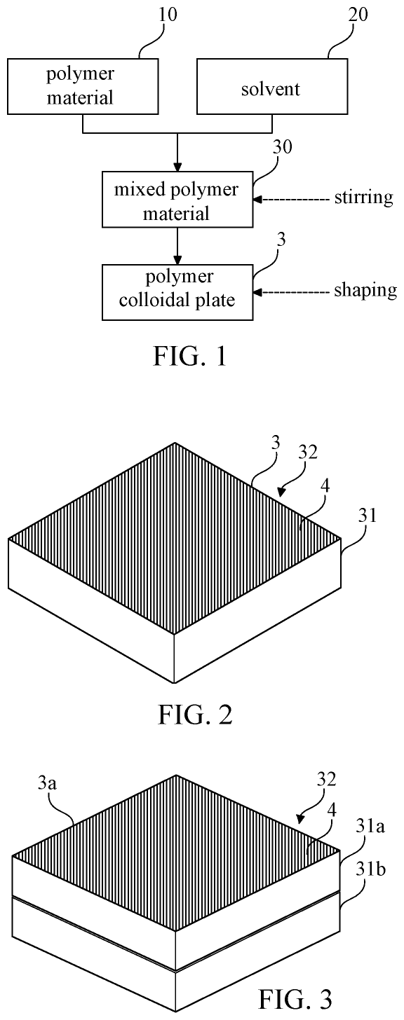

FIG. 1 shows a block diagram of a mixed polymer body plate according to a preferred embodiment of the present invention. Referring to FIG. 1, for example, the mixed polymer body plate according to the preferred embodiment of the present invention comprises at least one polymer material (such as a waste polymer material) 10, at least one solvent (or an organic solvent) 20, a mixed polymer material (mixed polymer material) 30, and a polymer colloidal plate 3.

Further referring to FIG. 1, for example, the polymer material 10 can also be selected as a recycled waste polymer material, and the polymer material 10 can be selected from various kinds of plastic material (such as: polyethylene (PE), polypropylene (PP), polystyrene (PS), or any combination thereof), various kinds of rubber material (such as: natural rubber, synthetic rubber, or any combination thereof), or a mixture thereof.

FIG. 2 is a schematic view showing a structure of a mixed polymer body plate according to a first preferred embodiment of the present invention, correspondingly implementing the mixed polymer body plate of FIG. 1. Referring to FIG. 2, for example, the structure of the mixed polymer body plate according to the preferred embodiment of the present invention comprises a plate body 31 and at least one plate front surface 32 or at least one plate back surface (not labeled), forming a raw material plate.

Further referring to FIG. 2, for example, the plate body 31 is selected to have a predetermined volume, a predetermined shape (such as: a triangular plate, a square plate, a rectangular plate, a polygonal shaped plate, or bodies of other shapes), a predetermined color (such as: a single color, a composite color combination, or other color combinations), or other specifications.

Further referring to FIG. 2, for example, the plate front surface 32 or other surfaces (such as: the plate back surface) is selected to have a predetermined shape (such as: a triangular plate surface, a square plate surface, a rectangular plate surface, a polygonal shaped plate surface, or plate surfaces of other shapes), a predetermined texture (such as: all sorts of wood texture, all sorts of marble texture, or other textures), a predetermined pattern, or other specifications, and the plate front surface 32 is arranged on the plate body 31 or other locations.

FIG. 3 is a schematic view showing a structure of a mixed polymer body plate according to a second preferred embodiment of the present invention, corresponding to the structure of the mixed polymer body plate of FIG. 2. Referring to FIG. 3, opposite to the first embodiment, the structure of the mixed polymer body plate according to the second preferred embodiment of the present invention may optionally comprises a first plate body 31a and a second plate body 31b, and the first plate body 31a and the second plate body 31b jointly form a composite multi-layered plate body, namely a dual-layered plate body.

Further referring to FIG. 3, for example, another preferred embodiment of the present invention may be selected to suit various needs by allowing the first plate body 31a and the second plate body 31b or other plate bodies to be optionally using a solvent 20, an organic solvent, or an organic solvent-contained material to form a composite multi-layered plate body, namely a multi-layered plate body.

Further referring to FIGS. 1, 2 and 3, for example, the polymer material 10 can be selected from an insoluble plastic, so that the insoluble plastic may form an aggregate, a recycled waste aggregate, or a material having a function similar to aggregate, and the waste aggregate of the polymer material 10 can be selected as all sorts of different recycled waste polymer materials, such as: a plastic material, a natural rubber, a synthetic rubber, or any combination thereof.

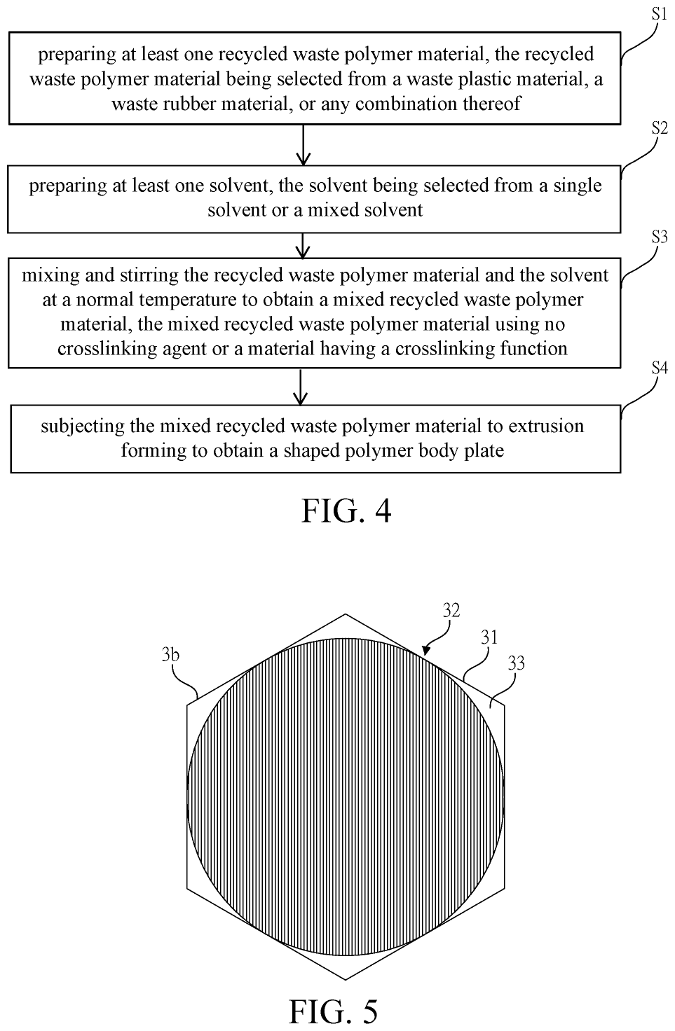

FIG. 4 is a flow chart showing a manufacturing method for a mixed polymer body plate according to a preferred embodiment of the present invention, correspondingly implementing the structure of the mixed polymer body plate of FIGS. 1, 2, and 3. Referring to FIG. 3, the manufacturing method for the mixed polymer body plate according to the preferred embodiment of the present invention comprises four steps (S1, S2, S3, S4), and the steps can be increased, decreased, combined, or permutated, or otherwise adjusted, but this is not intended to limit the scope of the present invention.

Referring to FIGS. 1, 2, 3 and 4, the manufacturing method for the mixed polymer body plate according to the preferred embodiment of the present invention comprises Step S1: firstly, for example, applying a proper technical measure (such as: an automatic manner, a semi-automatic manner, or a manually operating manner) to selectively prepare (such as: prefabrication) at least one kind or multiple kinds of polymer material 10 or a recycled waste polymer material, and the polymer material 10 can be a plastic material, a waste plastic material, a rubber material, a waste rubber material, or any combination thereof.

Further referring to FIGS. 1, 2, 3, and 4, for example, the polymer material 10 can be selected from a plastic fragment material, a waste plastic fragment material, a plastic sheet material, a waste plastic sheet material, a plastic powder material, a waste plastic powder material, or any combination thereof, and the polymer material 10 can be selected from a rubber fragment material, a waste rubber fragment material, a rubber sheet material, a waste rubber sheet material, a rubber powder material, a waste rubber powder material or any combination thereof.

Further referring to FIGS. 1, 2, 3, and 4, for example, the plastic material or the rubber material of the polymer material 10 can be selected from a material that is soluble in the organic solvent (such as: approximately 5 wt % to approximately 70 wt %), a material that is soluble in the solvent, a material that is insoluble in the organic solvent (such as: approximately 95 wt % to approximately 30 wt %), a material that is insoluble in the solvent, or any combination thereof.

Further referring to FIGS. 1, 2, 3, and 4, for example, the material that is soluble in the solvent or soluble in the organic solvent for the polymer material 10 or the recycled waste polymer material can be selected from an acrylonitrile butadiene styrene (ABS), polycarbonate (PC), polymethyl methacrylate (PMMA), polystyrene (PS), TPEQ (copolymer of styrene and butylene, a thermoplastic elastomer material), or any combination thereof.

Further referring to FIGS. 1, 2, 3, and 4, for example, the material that is insoluble in the solvent or insoluble in the organic solvent for the polymer material 10 or the recycled waste polymer material can be selected from a polyethylene (PE) material, a polypropylene (PP) material, a polyethylene terephthalate (PET) material, thermosetting, thermoplastic, an insoluble fossil waste plastic (rubber) material, a partially thermoplastic material, or any combination thereof.

Further referring to FIGS. 1, 2, 3, and 4, the manufacturing method for the mixed polymer body plate according to the preferred embodiment of the present invention comprises Step S2: next, for example, applying a proper technical measure (such as: an automatic manner, a semi-automatic manner, or a manually operating manner) to selectively prepare (such as: prefabrication) at least one kind or multiple kinds of solvent 20, and the solvent 20 is selected from a single solvent (solvent) or a mixed solvent.

Further referring to FIGS. 1, 2, 3, and 4, for example, the single solvent or the mixed solvent of the solvent 20 can be selected for proper adjustment to suit various different needs, and the solvent 20 can be selected from methylene chloride, acetone, ethyl acetate, or any combination thereof.

Further referring to FIGS. 1, 2, 3, and 4, the manufacturing method for the mixed polymer body plate according to the preferred embodiment of the present invention comprises Step S3: next, for example, applying a proper technical measure (such as: an automatic manner, a semi-automatic manner, or a manually operating manner) to selectively have the polymer material 10 or the recycled waste polymer material and the solvent 20 mixed and stirred at room temperature or around a normal temperature (such as: approximately 25° C.) to obtain a mixed polymer material 30, which forms a homogeneous solution material and the molecular structure of the high-molecule material thereof does not change.

Further referring to FIGS. 1, 2, 3, and 4, for example, the solvent 20 may properly dissolve a portion of the polymer material 10 or the rubber material (or the water plastic material, the waste rubber material, or other materials) to form at least one polymer material body (or a mixed polymer material body), so that the plastic material or the rubber material or the water plastic material, the waste rubber material, or other materials) of the polymer material 10 may be mixture of recycled plastic or rubber of different properties, and are collected and reused.

Further referring to FIGS. 1, 2, 3, and 4, for example, the polymer material body of the solvent 20 properly penetrates to attach and graft on the plastic material or the rubber material (or the waste plastic material, the waste rubber material, or other materials) of the polymer material 10, so that fusing/attaching grafting and hardening of the plastic material or the rubber material (or the waste plastic material, the waste rubber material, or other materials) of the polymer material 10 may be properly achieved to thereby form a predetermined shaped body, such as: a regular shape body or an irregular shape body.

Further referring to FIGS. 1, 2, 3, and 4, for example, the mixed polymer material 30 involves no cross linker or a material having a crosslinking function at all, and the mixing and stirring operation of the polymer material 10 with the solvent 20 (such as: a predetermined stirring speed or a stirring device) involves no heating or temperature increasing and the operation is performed for a predetermined period of time, and the predetermined period of time is adjustable to various needs for different degrees of homogeneity.

Further referring to FIGS. 1, 2, 3, and 4, the manufacturing method for the mixed polymer body plate according to the preferred embodiment of the present invention comprises Step S4: next, for example, applying a proper technical measure (such as: an automatic manner, a semi-automatic manner, or a manually operating manner) to selectively subject the mixed polymer material 30 (or the mixed recycled waste polymer material) to extrusion forming (such as: extrusion forming roller or extrusion forming machine) to obtain a shaped polymer material body plate (such as: a thin sheet plate, a small-size plate, or plates of other forms), namely forming a polymer colloidal plate 3 (as shown in FIGS. 1 and 2) or a multi-layered composite polymer material body plate 3a (as shown in FIG. 3), and the shaped polymer material body plate does not require a high-temperature heating plastic pelletizing operation.

Further referring to FIGS. 1, 2, 3, and 4, for example, the preferred embodiment of the present invention subjects the mixed polymer material 30 (or the mixed recycled waste polymer material) to extrusion forming at room temperature or around a normal temperature (such as: approximately 25° C.) and further subjects the mixed polymer material 30 (or the mixed recycled waste polymer material) to grafting hardening at room temperature) or around a normal temperature (such as: approximately 25° C.).

Further referring to FIGS. 1, 2, 3, and 4, for example, the shaped polymer material body plate (the polymer material body plate 3 or the multi-layered composite polymer material body plate 3a) selectively has an extrusion surface 4 on the plate front surface 32 or other surfaces (such as: the plate back surface), as shown in FIGS. 2 and 3.

Further referring to FIGS. 1, 2, 3, and 4, for example, in another preferred embodiment of the present invention, the mixed polymer material 30 (or the mixed recycled waste polymer material) is selectively added with at least one functional material, and the functional material is selected from a foaming agent, a processing aid, a fire retardant, a pigment, or any combination thereof.

Further referring to FIGS. 1, 2, 3, and 4, for example, the foaming agent is selected from a wet foaming agent or a dry foaming agent, and the wet foaming agent is selected from methylene chloride or acetone, and the dry foaming agent is selected from an inorganic foaming agent (such as: azodicarbonamide, azobisisobutyronitrile, or other inorganic foaming agents) or an organic foaming agent (such as: ammonium bicarbonate, ammonium carbonate, sodium bicarbonate, or other organic foaming agents), and is heated for foaming after hardening.

Further referring to FIGS. 1, 2, 3, and 4, for example, the shaped polymer material body plate (the polymer material body plate 3 or the multi-layered composite polymer material body plate 3a) is further processable to generate a processing waste (such as: cutting chips, trimmed edges, trimmed corners, or any combination thereof), and the processing waste can be selectively recycled as a recycled waste polymer material for further reuse.

FIG. 5 is a schematic view showing a structure of a mixed polymer body plate according to a third preferred embodiment of the present invention, corresponding to the structure of the mixed polymer body plate of FIGS. 2 and 3. Referring to FIG. 5, opposite to the first embodiment, in the structure of the mixed polymer body plate according to the third preferred embodiment of the present invention, the shaped polymer material body plate is a polygonal-shaped polymer material body plate 3b, and the polygonal-shaped polymer material body plate 3b has a plurality of trimmable edges 33.

Referring to FIG. 5, for example, the shaped polymer material body plate (the polygonal-shaped polymer material body plate 3b) is further processable to generate a plurality of processing wastes (the trimmable edges 33), based on various different needs, and the plurality of processing wastes waste can be selectively recycled as a recycled waste polymer material for further reuse.

For example, the mixed polymer body plate according to the preferred embodiment of the present invention selectively uses mixed fossil wastes (such as: plastic wastes or rubber wastes) that are not easily reused as raw material for being applied to make a raw material plate at a normal temperature, and as such, reduced carbon emission, low energy consumption, zero waste (namely making waste as resources) can be achieved, and no waste material or waste water that cause environmental pollution is generated.

Further, for example, the mixed polymer body plate according to the preferred embodiment of the present invention completely needs no addition of crosslinking agents for connecting between high-molecule materials, and it only needs to selectively add a solvent for temporary dissolution and distribution of the high-molecule materials for fulfilling the purposes of softening the high-molecule materials.

Further, for example, the mixed polymer body plate according to the preferred embodiment of the present invention only requires evaporation or removal of the solvent to become solidified from the liquid state to thereby form the raw material plate (such as: all sorts of solid plates or all sorts of boards), namely it can form a raw material plate.

Thus, it is appreciated from the above that the mixed polymer body plate and the manufacturing method thereof according to the present invention do not require addition of any crosslinking agent or a material having a crosslinking function, and the present invention can be produced at a normal temperature to have all sorts of plastic (or rubber) materials recycled and extruding for forming. Also, as the present invention can use all sorts of plastic (or rubber) materials and waste plastic (or rubber) materials, there is no constraint for materials. The present invention truly realizes advantages in regard to low emission, low energy consumption, and zero waste.

Particularly, the present invention can be produced at a normal temperature, and for the polymer body plate manufactured with the manufacturing method of the present invention, all sorts of plastic (or rubber) materials contained in the plate are not all fused together, and the present invention is such that, during the mixing of all sorts of plastic (or rubber) materials, molecules of high-molecule materials are introduced between the molecules to form mutually grafted solution material, and the molecular structure of the high-molecule material does not change, and afterwards, extrusion is applied to shape and form the plate, which is subjected to only physical change, but not chemical change. Thus, the polymer body plate according to the present invention possesses the advantages of being lightweight of the original plastic (or rubber) materials, and produces zero waste during the entire life cycle, and is recyclable and reusable, realizing an advantage of sustainable development of the environment.

Further, the mixed polymer body plate manufactured with the present invention, after being disposed of, can be completely recycled and can be produced again, through the manufacturing method of the present invention, to make the mixed polymer body plate for subsequent use. And, the present invention does not need heating and pelletizing and does not generate waste water and can save energy, and can truly achieve conversion of wastes into resources for repeated use and production to thereby fulfill sustainable development, high-degree environmental protection through reusability, and reducing production of plastic wastes. Thus, the present invention surely realizes high-degree inventiveness and utilization

I claim:

1. A mixed polymer body plate, comprising:
at least one polymer material, which is selected from a plastic material, a rubber material, or any combination thereof;
at least one solvent, which is selected from a single solvent or a mixed solvent;
a mixed polymer material, wherein the polymer material and the solvent are mixed and stirred at a normal temperature to obtain the mixed polymer material; and
a polymer body plate, wherein the mixed polymer material is subjected to extrusion forming to obtain a shaped polymer body plate;
wherein the mixed polymer material uses no crosslinking agent or a material having a crosslinking function.

2. The mixed polymer body plate according to claim 1, wherein the plastic material is selected from a plastic fragment material, a waste plastic fragment material, a plastic sheet material, a waste plastic sheet material, a plastic powder material, a waste plastic powder material, or any combination thereof, and the rubber material is selected from a rubber fragment material, a waste rubber fragment material, a rubber sheet material, a waste rubber sheet material, a rubber powder material, a waste rubber powder material, or any combination thereof.

3. The mixed polymer body plate according to claim 1, wherein the plastic material or the rubber material is selected from a material that is soluble in the solvent, a material that is soluble in the organic solvent, a material that is insoluble in the solvent, a material that is insoluble in the organic solvent, or any combination thereof.

4. The mixed polymer body plate according to claim 1, wherein the mixed polymer material is further added with at least one functional material.

5. The mixed polymer body plate according to claim 4, wherein the functional material is selected from a foaming agent, a processing aid, a fire retardant, a pigment, or any combination thereof.

6. A method for manufacturing a mixed polymer body plate, comprising:
preparing at least one polymer material, wherein the polymer material is selected from a plastic material, a rubber material, or any combination thereof;
preparing at least one solvent, wherein the solvent is selected from a single solvent or a mixed solvent;
mixing and stirring the polymer material and the solvent at a normal temperature to obtain a mixed polymer material, wherein the mixed polymer material uses no crosslinking agent or a material having a crosslinking function; and
subjecting the mixed polymer material to extrusion forming to obtain a shaped polymer body plate.

7. The method for manufacturing the mixed polymer body plate according to claim 6, wherein the solvent dissolves a portion of the plastic material or the rubber material to form at least one polymer material body.

8. The method for manufacturing the mixed polymer body plate according to claim 7, wherein the polymer material body is fusing and attaching for grafting on the plastic material or the rubber material.

9. The method for manufacturing the mixed polymer body plate according to claim 6, wherein the shaped polymer material body plate has an extrusion surface.

10. The method for manufacturing the mixed polymer body plate according to claim 6, wherein the shaped polymer material body plate is processable to generate a processing waste, and the processing waste recyclable and reusable as a recycled waste polymer material.
